(19) United States
(12) Patent Application Publication
(10) Pub. No.: US 2015/0044993 A1
(43) Pub. Date: Feb. 12, 2015

(54) Must Call

(71) Applicants: George Kirkley, Winston Salem, NC (US); Katrina Price, Rural Hall, NC (US)

(72) Inventors: George Kirkley, Winston Salem, NC (US); Katrina Price, Rural Hall, NC (US)

(21) Appl. No.: 13/932,934

(22) Filed: Aug. 7, 2013

(51) Int. Cl. H04W 12/08; H04M 1/725; H04W 4/00

(52) U.S. Cl. CPC H04W 12/08; H04W 4/001; H04M 1/72577
USPC 455/410

(57) ABSTRACT

The must call optional universal cell phone application is an application that provides better communication between parent(s) and guardian(s) with teenaged children who use cell phones, along with providing safety, by locking cell phone usage with programmed numbers until voice recognition is established even if the cell phone user is on the phone when programmed numbers call into the cell phone. The user has one minute to contact programmed numbers before cell phone locks them out. Also locks out text messaging but allows emergency phone calls i.e. 911 at any time.

### CROSS REFERENCE TO RELATED APPLICATIONS

None

### FEDERALLY SPONSORED RESEARCH

None

### SEQUENCE LISTING

None

### BACKGROUND

An application for cell phones used by under aged cell phone users. Preferably eighteen and under. We conceived this ideal when dealing with our own teenage daughters that would not call us back after we call them and it would take them hours to contact us back sometimes they did'nt bother to call back at all. As a parent with teenagers I know this application will help parents to communicate with their teenagers better and can also keep them out of trouble and can possibly save their lives. The cell phone application locks the cell phone and text messages. The cell phone user must call the phone numbers that have been programmed into the application. To unlock the cell phone the cell phone user must not only call but get a voice recognition from the programmed numbers i.e. parent(s) or guardian(s) and also from their end. If cell phone user is on the phone at the time when a programmed phone number comes through, the cell phone user has one minute to return phone call with voice recognition, before the cell phone locks them out. Emergency numbers will always be available. The must call numbers will be chosen by person(s) wanting the application added to cell phone. Application can be placed on new and used phones at any time. If application is no longer needed application can be removed.

### SUMMARY

An application to help parent(s) and guardian(s) help to keep their teenagers communicating with them and also helping keep them safe by passing information to them through their cell phones without getting ignored and never getting a call back. With this application the cell phone user “Must call back”.

1. A must call universal optional cell phone application a method, the method comprising the steps of:
A. keeping lines of communication open between teenagers' cell phone and parent(s) and guardian(s);
B. providing the teenager with one minute to return the phone call to parent(s) or the guardian(s) before the cell phone locks the teenager out;
C. locking down the cell phone until communication is established with voice recognition to parent(s) and or guardian(s),
wherein the locking down of the cell phone, includes text messaging until programmed numbers are contacted.
